(19) United States
(12) Patent Application Publication
(10) Pub. No.: US 2011/0206248 A1
(43) Pub. Date: Aug. 25, 2011

(54) IMAGING METHOD FOR SAMPLING A CROSS-SECTION PLANE IN A THREE-DIMENSIONAL (3D) IMAGE DATA VOLUME

(75) Inventor: Daniel Simon Anna Ruijters, Eindhoven (NL)

(73) Assignee: KONINKLIJKE PHILIPS ELECTRONICS N.V., EINDHOVEN (NL)

(21) Appl. No.: 12/673,511

(22) PCT Filed: Aug. 11, 2008
(86) PCT No.: PCT/IB08/53209

§ 371 Date: Feb. 15, 2010

(30) Foreign Application Priority Data
Aug. 16, 2007 (EP) 07114469.5

(51) Int. Cl. G06K 9/00

(52) U.S. Cl. 382/128

(57) ABSTRACT

Automated Vessel Analysis (AVA) allows qualitative and quantitative feedback to the user, regarding vessel pathologies (such as stenosis), with a minimum of user input. However, present algorithms may be unsuitable for large datasets, especially because of the rather long pre-processing time. Here an imaging method for placing probes on the vessel tree is presented that does not require any pre-processing time at 5 all, and performs very well on (very) large datasets, both in terms of speed and memory consumption. The method comprises the steps: classifying voxels of a 3D data volume as voxels of the first, the second or further types, determining a starting voxel in a tubular structure of voxels of the first type, determining the centre line in the proximity of the starting voxel, and fitting a plane through the starting voxel, perpendicular to the 10 centre line. Further the contour of the vessel cross-section on the plane can be determined, as well as its maximum, minimum and average diameter, and the area of the vessel cross-section.

The invention relates to the field of analysis of tubular objects in a three-dimensional data set, precisely to the field of Automatic Vessel Analysis (AVA). Automated Vessel Analysis allows qualitative and quantitative feedback to the user, regarding vessel pathologies (such as stenosis), with a minimum of user input. However, present algorithms may be unsuitable for large datasets, especially because of the rather long pre-processing time. The invention may be useful for minimal-invasive interventional treatment of vascular stenosis, as it is of great clinical importance to have an accurate assessment of the length of the stenosis, and the diameter of unoccluded vessel. Further, the invention may be available for high resolution reconstructions of vessel trees. It is also possible to use this method in the planning and modelling of stents and stentgrafts on CT or MR volumes. It would be natural to perform the modelling in a pre-processing/(re)viewing station. Further, the subject-matter of the invention can be used in interventional X-ray angiography procedures. It may be desirable to provide an augmented visibility of objects of interest in a grey scale or colour raster image.

Interventional X-ray angiography procedures are based on the real time 2D minimally invasive image guidance of endovascular material through the human vessels. The imaging modality of choice for the interactive tracking of the guide wires and catheters is the X-ray C-arm. 3D Rotational Angiography (3DRA) technique may significantly improve the standard 2D angiographic imaging by adding the third imaging dimension and as such allow a better understanding of vessel morphology and mutual relationship of vessel pathology and surrounding branches.

Automated Vessel Analysis is one of the more important functions that can be performed on 3DRA datasets. It allows qualitative and quantitative feedback to the user, regarding vessel pathologies (such as stenosis), with a minimum of user input. The standard AVA functionality consists of placing two probes on the vessel structure and a trace functionality. The probes allow a cross-sectional view on the vessel portion they are placed on, with quantitative feedback regarding the diameter of the vessel at the cross-section. The method can also be applied on other structures than vessels, especially tube-like structures.

The techniques behind the AVA functionality are documented by Jan Bruijns, see J. Bruijns, Semi-Automatic Shape Extraction from Tube-like Geometry. In Proceedings Vision Modeling and Visualization (VMV) 2000, Saarbruecken, Germany, pp. 347-355, November 2000, or J. Bruijns. Fully-Automatic Branch Labelling of Voxel Vessel Structures. In Proceedings Vision Modeling and Visualization (VMV) 2001, Stuttgart, Germany, November 2001, or J. Bruijns. Verification of the Self-adjusting Probe: Shape Extraction from Cerebral Vasculature. In Proceedings Vision Modeling and Visualization (VMV) 2003, Munich, Germany, pp. 159-166, November 2003.

Presently known AVA methods may have two major drawbacks: consuming a lot of memory, and requiring a pre-processing step, before the AVA functionality becomes available. This pre-processing step takes quite some time (time is precious during an intervention). The pre-processing can take more than 5 minutes for a 256 MB dataset (512³ voxels). Because of these drawbacks, the AVA functionality is not available for the highest resolution datasets.

These disadvantages may gain in significance, since faster reconstruction speeds and larger disk space lead to increasing usage of such large datasets.

Furthermore, the interactive use of high resolution reconstructions (e.g. of 512³ voxels), throughout the entire 3DRA (real-time link import, fast reconstruction, fast visualization, low waiting times, fast AVA), can form a key point for later applications.

It is one object of the invention to provide a method which requires less processing time.

Here a method for placing probes on the vessel tree is presented that may not require any pre-processing time at all, and performs well on (very) large datasets, both in terms of speed and memory consumption. The technical solution may enable instantaneous placement of probes and visualization of cross-sections, without any pre-processing time at all. Further, the claimed method demands very low memory consumption.

According to an exemplary embodiment of the present invention, an image processing method for sampling a cross-section plane in a three-dimensional (3D) image data volume of a subject is provided, wherein the image data volume contains voxels of at least a first type and a second type. The method comprises the steps of: classifying the voxels as voxels of the first, the second or further types, determining a starting voxel in a tubular structure (e.g. a vessel tree) of voxels of the first type in the three-dimensional (3D) image data volume, determining a first volume of interest comprising the starting voxel, assigning a data value to each voxel of the first type in the first volume of interest, wherein the data value representing a measure of the distance between said voxel and the nearest voxel of the second type, stepping from the starting voxel in gradient direction of the measured distance to a voxel with first local distance maximum, determining a second volume of interest comprising the first local maximum, acquiring all voxels in the second volume with local distance maximum, and applying a fitting function to the acquired voxels with a local maximum to determine a centre line through the tubular structure.

In a further embodiment, the method comprises the steps: classifying voxels of a 3D data volume as voxels of the first, the second or further types, determining a starting voxel in a tubular structure of voxels of the first type, determining the centre line in the proximity of the starting voxel, and fitting a plane through the starting voxel, perpendicular to the centre line.

In yet another embodiment, the method additionally enables to determine the contour of the vessel cross-section on the plane, as well as its maximum, minimum and average diameter, and the area of the vessel cross-section.

### Classifying the Voxels

The definition of the tubular structure, e.g. a vessel tree model, may be as follows: there are two thresholds, a lower threshold and a upper threshold. A voxel with a value below the lower threshold is considered to be a background voxel and is classified as a voxel of the second type. A voxel containing a value higher than the upper threshold is considered to be part of the vessel tree and is classified as a voxel of the first type. A voxel with a value between the lower and the higher threshold, is considered to be part of the vessel tree and, thus, classified as a voxel of the first type, if there is a neighbouring voxel with a value that is higher than the upper threshold within a box as a further volume of interest surrounding the voxel in question. If not, then it is considered to be a background voxel or voxel of the second type. A box size of 12³ voxels for the said box is preferably used, but the size can be chosen differently.

### Determining a Starting Voxel in a Tubular Structure

According to one embodiment of the invention, the image processing method further comprises the step of placing a probe by a user, wherein the user determines a starting voxel in a tubular structure e.g. by selecting a point on a screen. The selection may be done by a mouse click of a computer mouse. Precisely, a line in the 3D space can be defined by selected the point on the view screen, and the direction of a camera in the 3D space (screen normal). The intersection of this line and a model of the tubular structure, e.g. vessel tree, delivers the first point (starting voxel) for the probe and cross-section. If no intersection can be found, no probe can be placed. With the said embodiment of the invention, the tubular structure is defined implicitly by using the voxel data values, e.g. grey scale values.

In a further embodiment, the method may use a 3D version of Bresenham's algorithm for sampling the said line in the 3D data volume or additionally or alternatively for each other line in the voxel volume. Firstly, a line equation corresponding to the said line has to be transformed to the 3D voxel space. The line is sampled by using the 3D version of Bresenham's algorithm (J. E. Bresenham. Algorithm for computer control of a digital plotter. IBM Systems Journal, Vol. 4, No. 1, pp. 25-30, 1965). Then, a voxel of the actual sample location is classified by the previous described method.

### Determining a First Volume of Interest Comprising the Starting Voxel

Since the centreline needs to be found only in the neighbourhood of the starting voxel/intersection point, a first region of interest box around the intersection point is defined. Exemplarily, a box size of 100³ voxels is used. Then a binary volume is created, corresponding to the region of interest box, whereby the voxels of the second type, e.g. with values below the lower threshold are labelled as background voxels, and the voxels of the first type as vessel voxel.

### Assigning a Data Value to Each Voxel of the First Type in the First Volume of Interest

According to one embodiment of the invention, a distance transformation is performed on the voxels of the first type of the binary volume. Exemplary, this means that a vessel voxel (voxels of the first type) with a background voxel (voxels of the second type) as direct neighbour, is assigned distance 1. Vessel voxels neighbouring to voxels with distance 1, but not neighbouring background voxels are assigned distance 2, etc. Preferably, the N6 neighbourhood definition is used for distance transformation, meaning that voxels up, down, left, right, front, and back are considered as neighbours, but diagonally neighboured voxels are not.

Stepping from the Starting Voxel in Gradient Direction

The Skeleton voxels of a segmented tubular structure form its centreline. Ji and Piper, (L. Ji and J. Piper. Fast Homotropy-Preserving Skeletons Using Mathematical Morphology. In IEEE Transactions on Pattern Analysis and Machine Intelligence, Vol. 14, No. 6, pp. 653-664, June 1992), have shown that the local maxima in the Distance Transform are in fact skeleton points. Thus, rather than explicitly calculating the skeleton, a local maximum in the proximity of the intersection point is searched. This is done in the following manner: starting from the intersection point (starting voxel), stepping in the direction of the gradient of the Distance Transform, until a local maximum is found. This local maximum is the first skeleton point.

### Determining a Second Volume of Interest

A box around the first skeleton point is determined as the second volume of interest. The second volume gathers all local maxima (further skeleton points) of the Distance Transform inside this box. E.g. a box size of 16³ voxels is used for the second volume of interest, but different sizes are also possible.

### Applying a Fitting Function to the Acquired Voxels (Skeleton Points) to Determine a Centre Line Through the Tubular Structure

After a set of local maxima/skeleton points have been obtained, a vector has to be fitted to this set of points, to serve as normal of the cross-section (tangent vector of the vessel). The approach is based on fitting a line through a cloud of points, [see E. W. Weisstein. Least Squares Fitting—Perpendicular Offsets. From MathWorld—A Wolfram Web Resource, http://mathworld.wolfram.com/LeastSquaresFittingPerpendicularOffsets.html]. In the two-dimensional case the direction of a line fitted through a set of points may be:

$$\vec{v} = ( 1 , - B \pm \sqrt{{B}^{2} + 1} ) , \\ with$$

$$B = \frac{1}{2} \cdot \frac{\begin{matrix}[ {\sum }_{i = 1}^{n} {y}_{i}^{2} - \frac{1}{n} {( {\sum }_{i = 1}^{n} {y}_{i} )}^{2} ] - \\ [ {\sum }_{i = 1}^{n} {x}_{i}^{2} - \frac{1}{n} {( {\sum }_{i = 1}^{n} {x}_{i} )}^{2} ]\end{matrix}}{\frac{1}{n} {\sum }_{i = 1}^{n} {x}_{i} {\sum }_{i = 1}^{n} {y}_{i} - {\sum }_{i = 1}^{n} {x}_{i} {y}_{i}}$$

According to another exemplary embodiment, a weighting is added to the set of points. According to one embodiment of the invention, the image processing method comprises the steps of: weighting all acquired voxels of the second volume corresponding to their distance to the voxel with the first local maximum.

A weighting factor wᵢ may be defined with:

$${w}_{i} = \frac{1}{\sqrt{1 - dist ( {p}_{0} , {p}_{i} )}}$$

with dist as the Euclidian distance, p₀ as the 3D position of the first skeleton point, and pᵢ as the 3D position of the i-th skeleton point. This function is chosen to get a nice declining weighting function, for an increasing distance. But, of course, a different choice for wᵢ is also possible. Fitting lines in higher dimensions can be achieved by consecutive fitting a line in two dimensions. E.g. in the 3D dimensional case if the direction in the x,y-plane is (1, d_{xy}), and in the y,z-plane is (1, d_{yz}), then the 3D direction is (1, d_{xy}, d_{xy}·d_{yz}).

According to one embodiment of the invention, the image processing method further comprises the step of defining a cross section plane through the tubular structure; wherein a normal of the cross section plane is orientated parallel to the centre line and contains the starting voxel. In other words, the cross section plane is preferably perpendicular to the tangent of the tubular structure/vessel, which means that the normal of the plane should correspond to the tangent vector. The tangent vector can be found by determining the centreline of the vessel. If the vessel model consists of discrete points (voxels), then the centreline corresponds to the skeleton of the vessel model. Here, the intersection point p and the normal n now together define a cross-section plane according to the said embodiment.

According to another embodiment, a bitmap showing the cross-section can be created by interpolating the voxel intensities on the plane, and optionally applying a transfer function to the interpolated values.

According to one embodiment of the invention, the image processing method further comprises the step of determining a probe area of the tubular structure, wherein the probe area is the portion of voxels/pixels of the first type of the cross section plane. In other words, the probe area is the set of pixels on the cross-section bitmap that can be classified as vessel, and contain the intersection point or the starting voxel. This area is found as follows: take the projection of the first skeleton point on the cross-section bitmap along the fitted normal. Starting from this projected point, iteratively, every pixel in the bitmap that is connected to a vessel pixel is, and has an intensity higher than the lower threshold is classified as vessel pixel. Exemplarily, the connectivity can be defined as the N4 neighbourhood: up, down, left, right. The classification step is repeated on the entire bitmap, until no more vessel pixels are found.

According to a further embodiment, the classified voxels may be used for visualizing the voxel dataset. The lower and upper threshold in the algorithm described above could be derived from these visualization thresholds.

According to one embodiment of the invention, the image processing method further comprises the step of determining a probe contour of the probe area of the tubular structure, comprising the following steps with moving stepwise from an edge of the cross section plane in a positive or negative direction until a first contour voxel of the first type is found. The next contour voxel is found by considering all voxel neighbours of the first contour voxel in clockwise or counter clockwise stepping direction; wherein the first neighbour voxel of the first type having a neighbour voxel of the second type is determined as a second contour voxel, considering all voxel neighbours of the second contour voxel in previous stepping direction; wherein the first neighbour voxel of the first type having a neighbour voxel of the second type is determined as the third contour voxel, continuing the previous step for the third and all following contour voxels until the first determined contour voxel is encountered again.

In other words, any contour pixel/voxel would be fine to start with. The following way is preferred in one embodiment:

Starting from the left edge of the cross-section bitmap (x=0), at the y-coordinate that corresponds to the y-coordinate of the projected first skeleton point. Moving from this point to the positive x-direction until a vessel pixel is found. This is the first contour pixel.

Starting with the first contour pixel, the next contour pixel can be found, by considering all N8 neighbours in clockwise direction (counter clockwise would work as well). The first neighbouring pixel that is a vessel pixel is the next pixel in our contour. This scheme is continued until the starting contour pixel is encountered again.

According to one embodiment of the invention, the image processing method uses

a three-dimensional Bresenham algorithm for the sampling of voxels.

According to one embodiment of the invention, the image processing method further comprises the step: defining a centre and/or a minimum diameter and/or a maximum diameter and/or the size of the probe area.

The centre of the probe area may be defined as the average of all vessel pixel positions:

$${p}_{centre} = \frac{1}{n} ( {\sum }_{i = 1}^{n} {x}_{i} , {\sum }_{i = 1}^{n} {y}_{i} )$$

Consider a given contour pixel. The opposing contour point is defined as the intersection of a line from this given pixel through the probe centre and the contour outline. The diameter of the vessel at the given contour pixel is the distance between the contour pixel and its opposing contour point. The diameter can be expressed in millimetres by multiplying the distance in pixels with the pixel size in millimetres.

Further, consider the set of all diameters from all contour pixels. The minimum diameter is the smallest member of this set, and the maximum diameter the largest. It is also possible to calculate the average diameter from this set, and the area of the probe (in e.g. mm²) can be obtained by the multiplying the number of vessel pixels in the probe with the area of a single pixel.

According to one embodiment of the invention, an imaging system for sampling a cross-section plane in a three-dimensional (3D) image data volume of a subject is provided, wherein the image data volume contains voxels of at least a first type and a second type, the imaging system comprising a processor unit, adapted to carry out the steps of: classifying the voxels as voxels of the first, the second or further types; determining a starting voxel in a tubular structure of voxels of the first type in the three-dimensional (3D) image data volume; determining a first volume of interest comprising the starting voxel; assigning a data value to each voxel of the first type in the first volume of interest; wherein the data value representing a measure of the distance between said voxel and the nearest voxel of the second type; stepping from the starting voxel in gradient direction of the measured distance to a voxel with first local distance maximum; determining a second volume of interest comprising the first local maximum; acquiring all voxels in the second volume with local distance maximum; applying a fitting function to the acquired voxels with a local maximum to determine a centre line through the tubular structure.

According to one embodiment of the invention, a computer-readable medium for sampling a cross-section plane in a three-dimensional (3D) image data volume of a subject is provided, wherein the image data volume contains voxels of at least a first type and a second type, in which a computer program of examination of a tubular structure is stored which, when being executed by a processor, is adapted to carry out the steps of: classifying the voxels as voxels of the first, the second or further types; determining a starting voxel in a tubular structure of voxels of the first type in the three-dimensional (3D) image data volume; determining a first volume of interest comprising the starting voxel; assigning a data value to each voxel of the first type in the first volume of interest; wherein the data value representing a measure of the distance between said voxel and the nearest voxel of the second type; stepping from the starting voxel in gradient direction of the measured distance to a voxel with first local distance maximum; determining a second volume of interest comprising the first local maximum; acquiring all voxels in the second volume with local distance maximum; applying a fitting function to the acquired voxels with a local maximum to determine a centre line through the tubular structure.

According to one embodiment of the invention, a program element for sampling a cross-section plane in a three-dimensional (3D) image data volume of a subject, wherein the image data volume contains voxels of at least a first type and a second type is provided, which, when being executed by a processor, is adapted to carry out the steps of: classifying the voxels as voxels of the first, the second or further types; determining a starting voxel in a tubular structure of voxels of the first type in the three-dimensional (3D) image data volume; determining a first volume of interest comprising the starting voxel; assigning a data value to each voxel of the first type in the first volume of interest; wherein the data value representing a measure of the distance between said voxel and the nearest voxel of the second type; stepping from the starting voxel in gradient direction of the measured distance to a voxel with first local distance maximum; determining a second volume of interest comprising the first local maximum; acquiring all voxels in the second volume with local distance maximum; applying a fitting function to the acquired voxels with a local maximum to determine a centre line through the tubular structure.

One benefit of the embodiment may be the method ability to placing probes on a vessel tree, and, later, displaying the corresponding cross-section, without using pre-processing. The placement of the probes is instantaneous, even for huge datasets (e.g. of 1 GB). Further, the method is not very sensitive to noise, present in the dataset.

These and other aspects of the present invention will become apparent from and elucidated with reference to the embodiments described hereinafter.

Exemplary embodiments of the present invention will be described in the following, with reference to the following drawings.

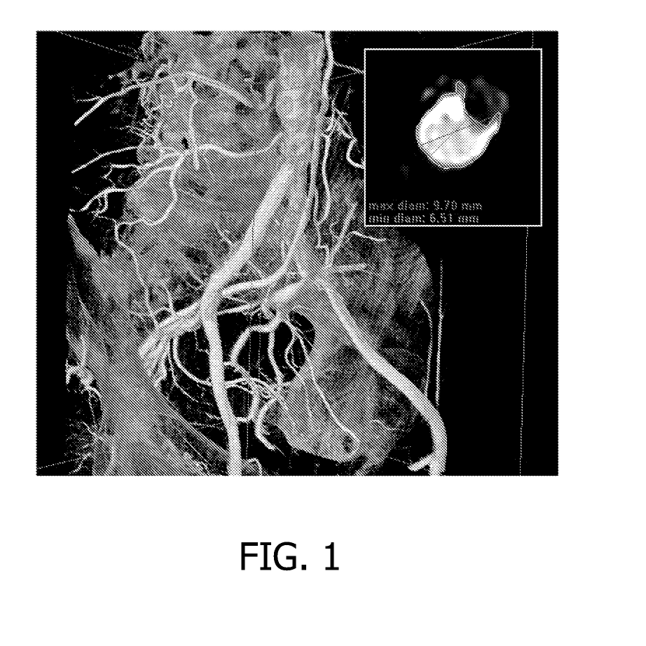

FIG. 1 shows a 3D image of a vessel tree and an pixel image of a probe area.

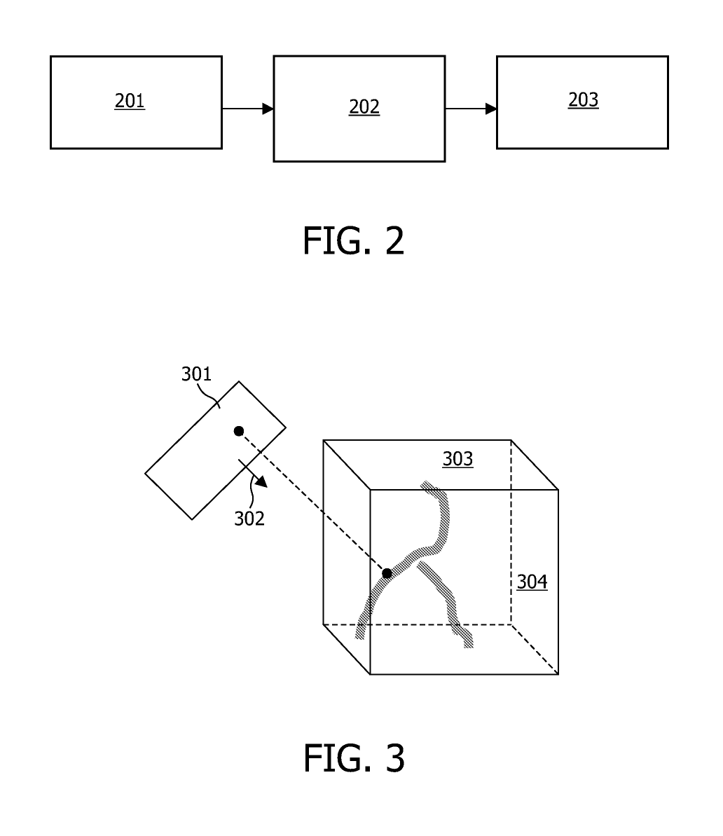

FIG. 2 shows a flow chart of an embodiment of the invention.

FIG. 3 shows a schematically view of a 3D volume containing a vessel tree model.

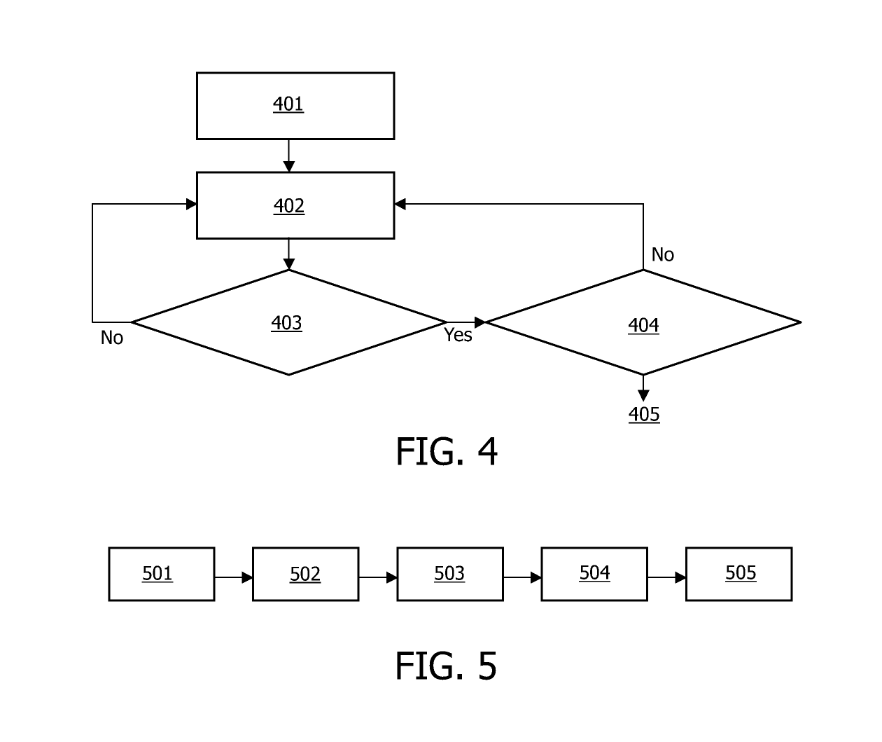

FIG. 4 shows a flow chart of a classification step.

FIG. 5 shows a flow chart of a fast tangent determination.

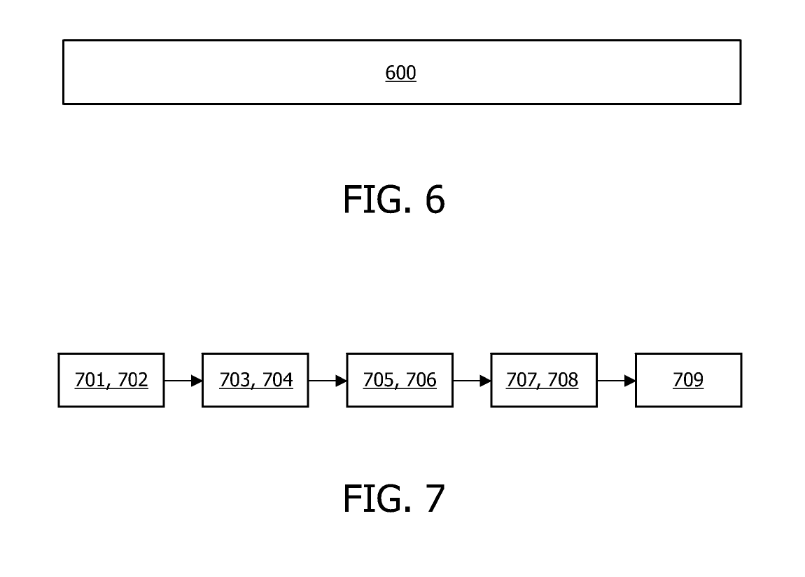

FIG. 6 shows a device adapted to perform the claimed method.

FIG. 7 shows a flow chart of an embodiment of the claimed method.

The illustration in the drawings is schematically. In different drawings, similar or identical elements are provided with the same reference numerals.

FIG. 1 shows a tubular structure, precisely a vessel tree in a three-dimensional (3D) image. In the upper right of the 3D image, a selected probe of the vessel is shown. The probe has a maximum diameter of 9.7 mm (dark grey) and a minimum diameter of 6.51 mm (light grey) and is captured with the claimed method.

FIG. 2 shows a flow chart of an algorithm which is used in one embodiment. In step 201 an intersection with a tubular structure is placed, e.g. by a mouse click. In step 202 a cross-section plane of the vessel is defined at the intersection point. In step 203 a probe is placed (see FIG. 1) and quantitative data of the probe are obtained.

According to FIGS. 2 and 3, placing a probe 203 is started by the user selecting a point on the screen 301 according to step 201 (usually by a mouse click). A line in the 3D space can be defined by the point on the view screen 301, and the direction of the camera in the 3D space 303 (screen normal 302). The intersection of this line and a model of the vessel tree 304, delivers the first point for the probe and cross-section according to step 202. If no intersection can be found, no probe can be placed.

FIG. 4 relates to the application of a Bresenham algorithm. In step 401 the line equation is transformed from Euclidian space to the voxel space (shown in FIG. 3, 303). The line is sampled using a 3D version of the Bresenham algorithm in step 402.

The vessel tree model may be defined by classifying the voxels as follows: there are two thresholds, a lower threshold and a upper threshold. A voxel v with a value below the lower threshold is considered to be a background voxel (“No” left side of 403). A voxel v containing a value higher than the upper threshold is considered to be part of the vessel tree (“Yes”, right side of step 402). A voxel v with a value between the lower and the higher threshold, is considered to be part of the vessel tree, if there is a voxel with a value that is higher than the upper threshold (Step 404) within a box surrounding the voxel v in question. If not, then it is considered to be a background voxel.

Preferably, a box size of 12³ voxels is used, but the size can be chosen differently.

In other words, in step 403 the question is if a voxel v at the sample location has a higher value than o lower threshold. If not (left side of box 403 it is a background voxel if yes in step 404 the question is if any voxel in the boy around voxel v is higher than the upper threshold. If yes an intersection v is found (box 405). If the answer is “No” the sampling of step 402 is repeated.

In FIG. 5 a flow chart, which relates to a method determining a tangent of the tubular structure at the starting voxel/intersection point is shown with the following five steps:

### Region of Interest

Since the centreline needs to be found only in the neighbourhood of the intersection point, a region of interest box around the intersection point is defined in step 501. We, for example, use a box size of 100³ voxels. Then a binary volume is created, corresponding to the region of interest box, whereby the voxels with values below the lower threshold are labelled as background voxels, and the others as vessel.

### Distance Transform

A Distance Transform is performed on the vessel voxels of the binary volume in step 502. This means that a vessel voxel with a background voxel as direct neighbour, is assigned distance 1. Vessel voxels neighbouring to voxels with distance 1, but not neighbouring background voxels are assigned distance 2, etc. We use the N6 neighbourhood definition, meaning that voxels up, down, left, right, front, and back are considered neighbours, but diagonal voxels are not.

### Walk to Maximum

Ji and Piper have shown that the local maxima in the Distance Transform are in fact skeleton points. Thus, rather than explicitly calculating the skeleton, we search for a local maximum in the proximity of the intersection point. This is done in the following manner: starting from the intersection point we step in the direction of the gradient of the Distance Transform in step 503, until a local maximum is found. This local maximum is our first skeleton point.

### Find Siblings

Now we have the first skeleton point, but we need several skeleton points to determine the direction of the centreline at this particular position. Therefore we define a box around the first skeleton point and gather all local maxima of the Distance Transform inside this box in step 504. Here we use a box size of 16³ voxels, but different sizes are possible.

### Fit Normal

A set of skeleton points have been obtained, and a vector has to be fitted to this set of points in step 505, to serve as normal of the cross-section (tangent vector of the vessel). Our approach is based on fitting a line through a cloud of points. In the two-dimensional case the direction of a line fitted through a set of points is:

$$\vec{v} = ( 1 , - B \pm \sqrt{{B}^{2} + 1} ) , \\ with$$

$$B = \frac{1}{2} \cdot \frac{\begin{matrix}[ {\sum }_{i = 1}^{n} {y}_{i}^{2} - \frac{1}{n} {( {\sum }_{i = 1}^{n} {y}_{i} )}^{2} ] - \\ [ {\sum }_{i = 1}^{n} {x}_{i}^{2} - \frac{1}{n} {( {\sum }_{i = 1}^{n} {x}_{i} )}^{2} ]\end{matrix}}{\frac{1}{n} {\sum }_{i = 1}^{n} {x}_{i} {\sum }_{i = 1}^{n} {y}_{i} - {\sum }_{i = 1}^{n} {x}_{i} {y}_{i}}$$

However, we added a weighting to the points in the cloud. The rational is that we want points that are close to the first skeleton point, to have a larger impact on the direction of the fitted normal, than points that are further away. Therefore B is calculated in our case as follows:

$$B = \frac{1}{2} \cdot \frac{\begin{matrix}[ {\sum }_{i = 1}^{n} {w}_{i} ( {y}_{i}^{2} ) - \frac{1}{{\sum }_{i = 1}^{n} {w}_{i}} {( {\sum }_{i = 1}^{n} {w}_{i} {y}_{i} )}^{2} ] - \\ [ {\sum }_{i = 1}^{n} {w}_{i} ( {x}_{i}^{2} ) - \frac{1}{{\sum }_{i = 1}^{n} {w}_{i}} {( {\sum }_{i = 1}^{n} {w}_{i} {x}_{i} )}^{2} ]\end{matrix}}{\frac{1}{{\sum }_{i = 1}^{n} {w}_{i}} {\sum }_{i = 1}^{n} {w}_{i} {x}_{i} {\sum }_{i = 1}^{n} {w}_{i} {y}_{i} - {\sum }_{i = 1}^{n} {w}_{i} {x}_{i} {y}_{i}}$$

We defined the weighting factor wᵢ as follows:

$${w}_{i} = \frac{1}{\sqrt{1 - dist ( {p}_{0} , {p}_{i} )}}$$

with dist as the Euclidian distance, p₀ as the 3D position of the first skeleton point, and pᵢ as the 3D position of the

i-th skeleton point. We chose this function to get a nice declining weighting function, for an increasing distance. But, of course, a different choice for wᵢ is also possible.

Fitting lines in higher dimensions can be achieved by consecutive fitting a line in two dimensions. E.g. in the 3D dimensional case if the direction in the x,y-plane is (1, d_{xy}), and in the y,z-plane is (1, d_{yz}), then the 3D direction is (1, d_{xy}, d_{xy}·d_{yz}).

FIG. 6 shows schematically an imaging system for sampling a cross-section plane in a three-dimensional (3D) image data volume of a subject according to claim 8. Further, FIG. 6 shows schematically a computer-readable medium, as a CD ROM for sampling a cross-section plane in a three-dimensional (3D) image data volume according to claim 9 and a processor according to claim 10.

FIG. 7 shows a flow chart of an image processing method for sampling a cross-section plane in a three-dimensional (3D) image data volume of a subject, wherein the image data volume contains voxels of at least a first type and a second type; the method comprising the steps of classifying 701 the voxels as voxels of the first, the second or further types, determining 702 a starting voxel in a tubular structure of voxels of the first type in the three-dimensional (3D) image data volume, determining 703 a first volume of interest comprising the starting voxel, assigning a data value to each voxel of the first type in the first volume of interest 704; wherein the data value representing a measure of the distance between said voxel and the nearest voxel of the second type;

stepping from the starting voxel in gradient direction 705 of the measured distance to a voxel with first local distance maximum, determining a second volume of interest 706 comprising the first local maximum, acquiring all voxels in the second volume with local distance maximum 708, and applying 709 a fitting function to the acquired voxels with a local maximum to determine a centre line through the tubular structure.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. An image processing method for sampling a cross-section plane in a three-dimensional (3D) image data volume of a subject, wherein the image data volume contains voxels of at least a first type and a second type; the method comprising the steps of:
classifying the voxels as voxels of the first, the second or further types;
determining a starting voxel in a tubular structure of voxels of the first type in the three-dimensional (3D) image data volume;
determining a first volume of interest comprising the starting voxel;
assigning a data value to each voxel of the first type in the first volume of interest; wherein the data value representing a measure of the distance between said voxel and the nearest voxel of the second type;
stepping from the starting voxel in gradient direction of the measured distance to a voxel with first local distance maximum;
determining a second volume of interest comprising the first local maximum;
acquiring all voxels in the second volume with local distance maximum;
applying a fitting function to the acquired voxels with a local maximum to determine a centre line through the tubular structure.

2. The image processing method as defined by claim 1, further comprising the step:
defining a cross section plane through the tubular structure; wherein a normal of the cross section plane is orientated parallel to the tangent of the centre line at its intersection with the plane, and contains the starting voxel.

3. The image processing method according to claim further comprising the step:
determining a probe area of the tubular structure; wherein the probe area is the portion of voxels of the first type, intersecting with the cross section plane.

4. The image processing method according to claim 1, further comprising the steps of:
determining a probe contour of the probe area of the tubular structure, comprising the following steps:
moving stepwise from an edge of the cross section plane in a positive or negative direction until a first contour voxel of the first type is found;
considering all voxel neighbours of the first contour voxel in clockwise or counter clockwise stepping direction; wherein the first neighbour voxel of the first type having a neighbour voxel of the second type is determined as a second contour voxel;
considering all voxel neighbours of the second contour voxel in previous stepping direction; wherein the first neighbour voxel of the first type having a neighbour voxel of the second type is determined as the third contour voxel;
continuing the previous step for the third and all following contour voxels until the first determined contour voxel is encountered again.

5. The image processing method according to claim 1; wherein
sampling of voxels using a three-dimensional Bresenham algorithm.

6. The image processing method as defined by claim 1, further comprising the steps of:
weighting all acquired voxels of the second volume corresponding to their distance to the voxel with the first local maximum.

7. The image processing method according to claim 1, further comprising the step:
define a centre and/or a minimum diameter and/or a maximum diameter and/or the size of the probe area.

8. An imaging system for sampling a cross-section plane in a three-dimensional (3D) image data volume of a subject, wherein the image data volume contains voxels of at least a first type and a second type, the imaging system comprising a processor unit, adapted to carry out the steps of:
classifying the voxels as voxels of the first, the second or further types;
determining a starting voxel in a tubular structure of voxels of the first type in the three-dimensional (3D) image data volume;
determining a first volume of interest comprising the starting voxel;
assigning a data value to each voxel of the first type in the first volume of interest; wherein the data value representing a measure of the distance between said voxel and the nearest voxel of the second type;
stepping from the starting voxel in gradient direction of the measured distance to a voxel with first local distance maximum;
determining a second volume of interest comprising the first local maximum;
acquiring all voxels in the second volume with local distance maximum;
applying a fitting function to the acquired voxels with a local maximum to determine a centre line through the tubular structure.

9. A computer-readable medium for sampling a cross-section plane in a three-dimensional (3D) image data volume of a subject, wherein the image data volume contains voxels of at least a first type and a second type, in which a computer program of examination of a tubular structure is stored which, when being executed by a processor, is adapted to carry out the steps of:
classifying the voxels as voxels of the first, the second or further types;
determining a starting voxel in a tubular structure of voxels of the first type in the three-dimensional (3D) image data volume;
determining a first volume of interest comprising the starting voxel;
assigning a data value to each voxel of the first type in the first volume of interest; wherein the data value representing a measure of the distance between said voxel and the nearest voxel of the second type;
stepping from the starting voxel in gradient direction of the measured distance to a voxel with first local distance maximum;
determining a second volume of interest comprising the first local maximum;
acquiring all voxels in the second volume with local distance maximum;
applying a fitting function to the acquired voxels with a local maximum to determine a centre line through the tubular structure.

10. A program element for sampling a cross-section plane in a three-dimensional (3D) image data volume of a subject, wherein the image data volume contains voxels of at least a first type and a second type, which, when being executed by a processor, is adapted to carry out the steps of:
classifying the voxels as voxels of the first, the second or further types;
determining a starting voxel in a tubular structure of voxels of the first type in the three-dimensional (3D) image data volume;
determining a first volume of interest comprising the starting voxel;
assigning a data value to each voxel of the first type in the first volume of interest; wherein the data value representing a measure of the distance between said voxel and the nearest voxel of the second type;
stepping from the starting voxel in gradient direction of the measured distance to a voxel with first local distance maximum;
determining a second volume of interest comprising the first local maximum;
acquiring all voxels in the second volume with local distance maximum;
applying a fitting function to the acquired voxels with a local maximum to determine a centre line through the tubular structure.
